(19) United States
(12) Patent Application Publication
(10) Pub. No.: US 2007/0279240 A1
(43) Pub. Date: Dec. 6, 2007

(54) EARTHQUAKE ALARM CLOCK

(76) Inventors: Shin-Hua CHOW, Taipei (TW); Chih-Chien You, Miao Li City (TW); I-Chuan Hsu, Miao Li City (TW); Tien-Chung Hu, Taipei (TW); I-Huan Shih, Miao Li City (TW); Wen-Chan Hsien, Miao Li City (TW)

Correspondence Address: SINORICA, LLC, 528 FALLSGROVE DRIVE, ROCKVILLE, MD, 20850, US

(21) Appl. No.: 11/755,759

(22) Filed: May 31, 2007

(30) Foreign Application Priority Data
Jun. 1, 2006 (CN) 200620118178.7

(51) Int. Cl. G08B 21/00

(52) U.S. Cl. 340/690

(57) ABSTRACT

An earthquake alarm clock includes a time display device for displaying time with a beeper and a detecting device. The time display device has a guiding member, along which a movable member runs. When an earthquake takes place, the movable member runs along the guiding member and hits the detecting device. The detecting device is electrically connected the beeper to command the beeper broadcasting an alarm when the detecting device is started.

### BACKGROUND OF THE INVENTION

1. Field of the Invention

The present invention relates generally to a time display, and more particularly to an earthquake alarm clock.

2. Description of the Related Art

Natural disasters, especially for an earthquake with greater magnitude and intensity, usually cause serious damage in lives and properties. Earthquakes are occurred in Taiwan frequently. If an earthquake is occurred at day time, people are awake and have high alertness to save his/her life. But, if an earthquake is occurred at night, people are asleep that usually causes serious damage of life.

In the market, there are earthquake alarm to alarm people when earthquake takes place. However, if the article for daily use is equipped with earthquake alarm, they will attract consumer to buy for protection of life and property.

### SUMMARY OF THE INVENTION

The primary objective of the present invention is to provide a earthquake alarm clock, which has all functions of a clock and further has earthquake alarm function when an earthquake takes place.

According to the objective of the present invention, an earthquake alarm clock includes a time display device for displaying time, a beeper provided in the time display device, and a detecting device provided in the time display device and electrically connected the beeper. The detecting device detects a vibration and sends a signal to the beeper for broadcasting an alarm when the vibration is detected.

### BRIEF DESCRIPTION OF THE DRAWINGS

FIG. 1 is a perspective view of a first preferred embodiment of the present invention;

FIG. 2 is a lateral view of the first preferred embodiment of the present invention;

FIG. 3 is a front view of the preferred embodiment of the present invention, showing the earthquake alarm function;

FIG. 4 is a perspective view of a second preferred embodiment of the present invention;

FIG. 5 is a sketch diagram of a third preferred embodiment of the present invention in operation; and

FIG. 6 is a sketch diagram of a fourth preferred embodiment of the present invention in operation.

### DETAILED DESCRIPTION OF THE INVENTION

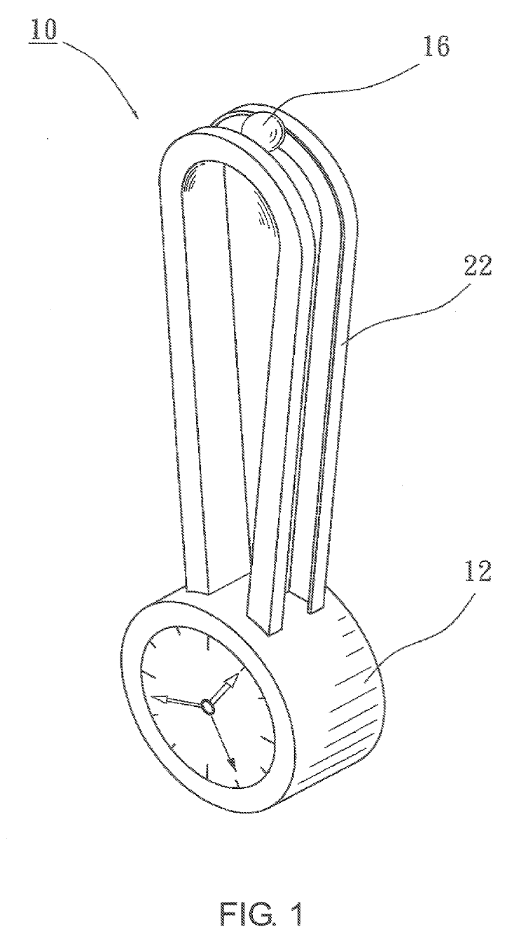

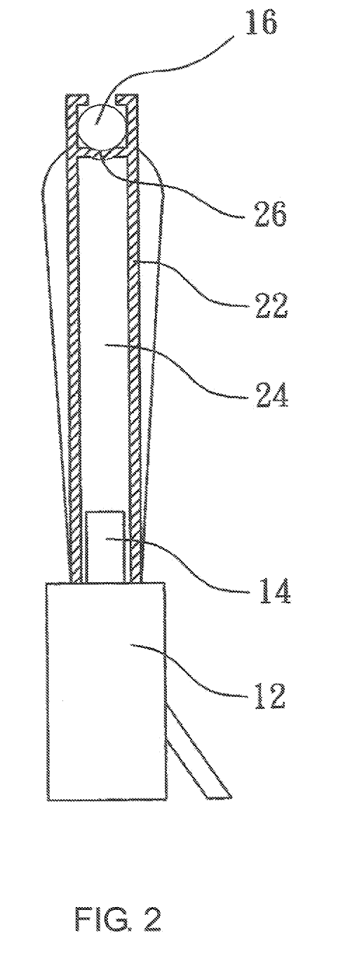

As shown in FIG. 1 and FIG. 2, an earthquake clock 10 of the first preferred embodiment of the present invention includes a time display device 12, a beeper (not shown) and a detecting device 14. The time display device 12 is a conventional clock with an hour hand and a minute hand or an electronic clock (not shown) with a screen to show time. The beeper is mounted in the time display device 12. The time display device 12 has an arched guiding member 22, which has a rail 24, at a top thereof. The rail 24 is a slot with a positioning portion 26, which is a recess, at a top thereof. The detecting device 14, which is a conventional infrared ray sensor, is mounted at a bottom of the guiding member 22 and electrically connected to the beeper. The present invention further provides a movable member 16, which is a ball, received in the rail 24 for free running. The movable member 16 is positioned at the positioning portion 26 of the rail 24 at an initial condition.

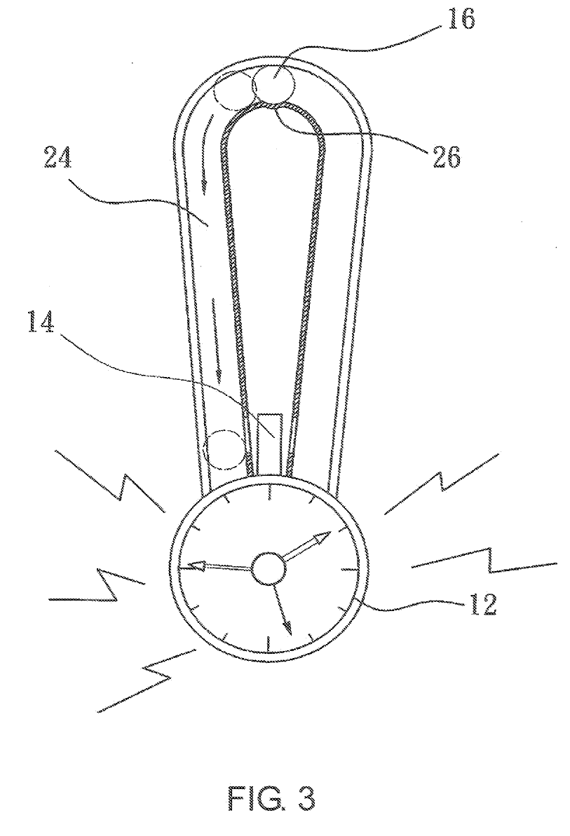

The earthquake alarm clock 10 of the present invention may be placed on any flat surface in home or hung on a wall. The earthquake alarm clock 10 of the present invention is a clock in normal time. When an earthquake takes place, as shown in FIG. 3, the earthquake alarm clock 10 is shaken that the movable member 16 will fall along a right or a left of the rail 24 to the bottom thereof from the positioning position 26 and hit the detecting device 14 that the beeper will broadcast a sound to alarm people running for his/her life.

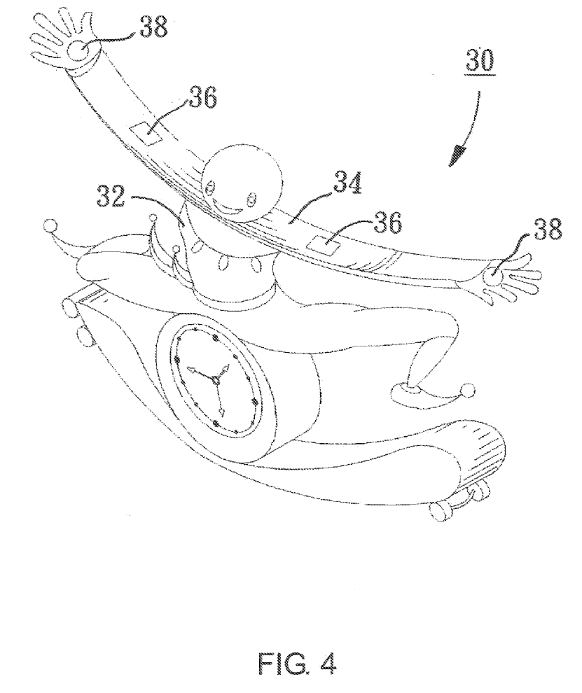

As shown in FIG. 4, an earthquake alarm clock 30 of the second preferred embodiment of the present invention, which is similar to the earthquake alarm clock 10 of the first preferred embodiment, except that a guiding member 32 has a clown aspect with the arms of the clown is a rail 34 of the guiding member 32. Two detecting devices 36, which are two conventional microswitches, are mounted on opposite ends of the rail 34 (hands of the clown). A movable member 38 is placed on the rail for reciprocation to hit the detecting devices 36 to make an alarm when an earthquake takes place.

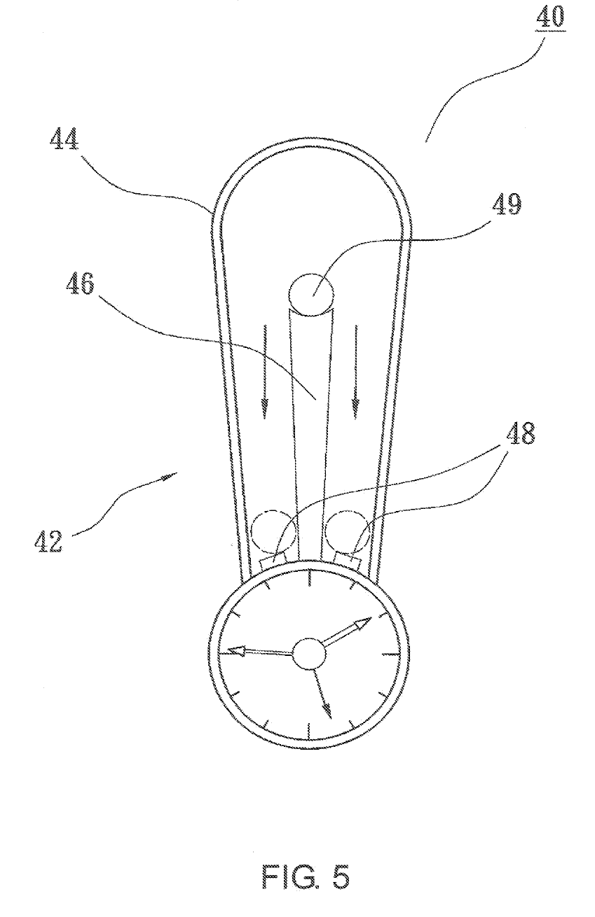

As shown in FIG. 5, an earthquake alarm clock 40 of the third preferred embodiment of the present invention, which is similar to the earthquake alarm clock 10 of the first preferred embodiment, except that a guiding member 42, without the rail, includes a case 44 and a support member 46 in the case 44. Two detecting devices 48 are mounted in the case 44 at a bottom side thereof. A movable member 49 is placed on a top of the support member 46 that the movable member 49 will fall from the support member 46 and hit the detecting devices 48 when an earthquake takes place.

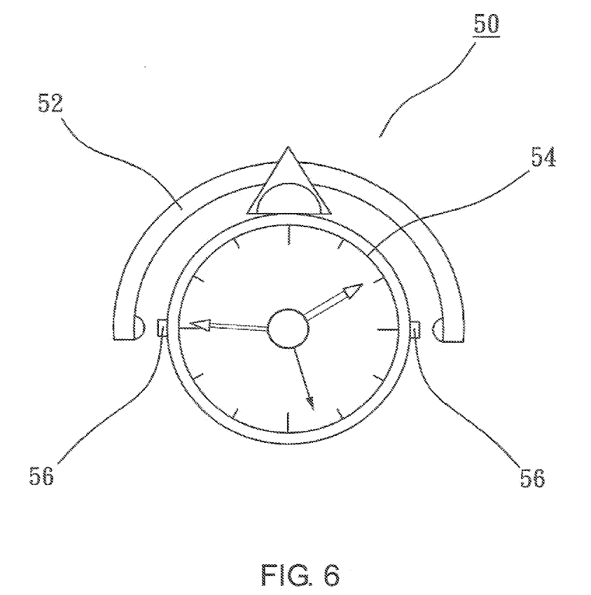

As shown in FIG. 6 an earthquake alarm clock 50 of the fourth preferred embodiment of the present invention, which is similar to the earthquake alarm clock 10 of the first preferred embodiment, except that a movable member 52 is a lever pivoted on a top pf a clock 54 and two detecting devices 56 are mounted on the top of the clock 54 and under opposite sides of the lever 52, therefore, the movable member 52 (the lever) will swing and hit the detecting devices 56 thereunder when an earthquake takes place.

In addition, the earthquake alarm clock of the present invention may be equipped with fluorescence pieces, lamp, radio transmitter, radio, frequency modulation communicator or hand-drive power generator (not shown) to save life and call for help when an earthquake takes place and user is buried under the house.

It has to be mentioned that the detecting device of the present invention may be any suitable detector except for infrared ray sensor and microswitch. The detecting device may be a vibration sensor which may sense vibration without the movable member.

The description above is a few preferred embodiments of the present invention and the equivalence of the present invention is still in the scope of the claim of the present invention.

What is claimed is:

1. An earthquake alarm clock, comprising:
a time display device for displaying time;
a beeper provided in the time display device; and
a detecting device provided in the time display device and electrically connected the beeper for detecting a vibration and sending a signal to the beeper for broadcasting an alarm when the vibration is detected.

2. The earthquake alarm clock as defined in claim 1, further comprising a movable member on the time display device to start the detecting device.

3. The earthquake alarm clock as defined in claim 2, wherein the time display device has a positioning portion, in which the movable member is positioned in an initial condition.

4. The earthquake alarm clock as defined in claim 3, wherein the time display device has a guiding member, on which the positioning portion is provided, to guide a movement of the movable member.

5. The earthquake alarm clock as defined in claim 4, wherein the guiding member has a rail on which the positioning portion is provided.

6. The earthquake alarm clock as defined in claim 5, wherein the positioning portion is a recess.

7. The earthquake alarm clock as defined in claim 6, wherein the movable member is a ball.

8. The earthquake alarm clock as defined in claim 6, wherein the time display device is a clock with a minute hand and an hour hand.

9. The earthquake alarm clock as defined in claim 1, wherein the time display device is an electronic clock with a screen to show time.
